(19) United States
(12) Patent Application Publication
(10) Pub. No.: US 2026/0353104 A1
(43) Pub. Date: Nov. 5, 2026

(54) COVERAGE AWARE RADIO ACCESS NETWORK ENERGY SAVING

(71) Applicant: T-MOBILE INNOVATIONS LLC., Overland Park, KS (US)

(72) Inventor: Roopesh Kumar POLAGANGA, Bothell, WA (US)

(21) Appl. No.: 19/196,431

(22) Filed: May 1, 2025

(51) Int. Cl. H04W 16/28; H04L 41/5009; H04W 52/02

(52) U.S. Cl. CPC H04W 16/28; H04L 41/5009; H04W 52/0203

(57) ABSTRACT

Methods, media, and systems are provided for mitigating loss of coverage (LoC) associated with an energy savings opportunity. The energy saving opportunity, such as a cell sleep technique, may be initiated. One or more key performance indicators (KPIs) associated with the LoC caused by the energy saving opportunity may be received, and, based on the one or more KPIs, a geographic coverage area affected by the LoC may be determined. The operations further include implementing a mitigation measure to mitigate the LoC affecting the geographic coverage area. These mitigation measures can include adjusting the tilt of neighboring cell sites to improve coverage, recommending the construction of new cell sites, or waking up cells that were put to sleep. The mitigation measures may be selected based on the severity of the LoC and the number of users impacted.

### SUMMARY

A high-level overview of various aspects of the invention are provided here to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to mitigating loss of coverage (LoC) associated with an energy saving opportunity, substantially as shown in and/or described in connection with at least one of the figures, and as set forth more completely in the claims.

In aspects set forth herein, and at a high level, the technology described herein relates to initiating an energy savings opportunity and mitigating LoC associated with the energy savings opportunity. As such, the operations of the present disclosure comprise initiating an energy saving opportunity, such as utilizing a cell sleep technique. The operations further comprise receiving one or more key performance indicators (KPIs) associated with the LoC caused by the energy saving opportunity, and, based on the one or more KPIs, determining a geographic coverage area affected by the LoC. The operations further include implementing a mitigation measure to mitigate the LoC affecting the geographic coverage area. In other words, the present disclosure may implement mitigation measures to address the LoC in the affected geographic coverage area. These mitigation measures can include adjusting the tilt of neighboring cell sites to improve coverage, recommending the construction of new cell sites, or waking up cells that were put to sleep. In some examples, the mitigation measures are selected based on the severity of the LoC and the number of users impacted.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for mitigating loss of coverage (LoC) associated with an energy saving opportunity, in accordance with aspects herein;

FIG. 2 depicts an example block diagram of mitigating loss of coverage (LoC) associated with an energy saving opportunity, in accordance with aspects herein;

FIG. 3 depicts an example block diagram of a mitigation measure component of a mitigation module, in accordance with aspects herein;

FIG. 4 illustrates an example flowchart for mitigating loss of coverage (LoC) associated with an energy saving opportunity, in accordance with aspects herein;

FIG. 5 illustrates another example flowchart for mitigating loss of coverage (LoC) associated with an energy saving opportunity, in accordance with aspects herein; and

FIG. 6 depicts an example computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

In recent years, telecommunications networks have worked towards improving their operational expenditure (OpEx) to lower their energy bills accumulated from operating their networks. To achieve these savings, telecommunications networks have implemented several energy saving opportunities (e.g., cost saving initiatives), such as implementing features on the radio access network (RAN). For example, when considering the energy saving optimization of a cell site (e.g., an energy saving opportunity), most of the consumption of energy is typically related to the radio functions of the cell site. That is, because the radios of a cell site use up large amounts of energy to facilitate air interface transmission of radio frequencies, the radio functions of a cell site typically consume the most power associated with the cell site. For instance, a radio module may contribute around 70% of a cell site's power consumption, while a baseband module (e.g., the processing unit centralized on the cell site that processes the radio interface messages) may consume only 10% and the remaining 20% may be distributed among other aspects of the cite site, such as the power plant, transport, batteries, and other ancillary modules.

Accordingly, due to the power consumption associated with radio use, many telecommunications networks have attempted to implement energy saving opportunities on the RAN. For example, telecommunication networks have implemented energy saving opportunities by altering radio aspects of cell sites. For instance, conventional energy saving opportunities include cell sleep, which typically comprises four separate cell sleep methods: (1) Massive Multiple Input Multiple Output (M-MIMO) sleep, (2) time-based sleep, (3) traffic-based sleep, and (4) intent-based sleep. In addition to these cell sleep methods, there may also be a scheduler level power allocation that can be used as a power savings method (e.g., a programmable scheduler that allows an operator to allocate power levels as needed).

One of the challenges faced by telecommunications networks implementing energy saving opportunities is that the telecommunications networks often fail to consider potential coverage losses for users, leading to significant issues for both network operators and customers. In other words, while energy saving opportunities help telecommunications networks to lower their energy bills and improve their OpEx, implementing energy saving opportunities often leads to lose of coverage (LoC) for customers. Unfortunately, this LoC may lead to customer churn.

Aspects provided herein address the need for a method and system for mitigating LoC associated with energy saving opportunities. Aspects are provided for processing key performance indicators (KPIs) and per call measurement data (PCMD) to monitor and analyze LoC in real-time. When LoC is detected, the system can either slow down the energy saving opportunity (e.g., an energy saving method) or implement mitigation measures such as adjusting the tilt of neighboring cell sites to cover the geographic coverage area affected by the LoC. This approach may continue to utilize energy saving opportunities without compromising the quality of service (QoS) for users (e.g., customers).

As described herein, aspects are directed to the mitigation or avoidance of LoC associated with energy saving opportunities. According to the present disclosure, when an energy saving opportunity (e.g., M-MIMO cell sleep, time-based cell sleep, traffic-based cell sleep, or intent-based cell sleep) is initiated, an LoC associated with the energy saving opportunity is determined. Based on one or more KPIs associated with the LoC caused by the energy saving opportunity, the present disclosure may determine a geographic coverage area affected by the LoC and may implement a mitigation measure to mitigate the LoC affecting the geographic coverage area.

By way of background, it is difficult for a telecommunications network to determine where its services (e.g., coverage) is not available. For example, the telecommunications network may assume that it is covering a certain area (e.g., geographical coverage area), as well as all the users within that area, but conventional telecommunications networks often struggle to determine when users in that supposedly covered area lose coverage. In other words, the conventional telecommunications networks may believe that a certain geographical coverage area, as well as the users within that area, are being covered, but these telecommunications networks often are not aware of when LoC occurs in that area, especially when an energy saving opportunity is initiated.

The present solution may be mindful of the LoC while trying to implement energy saving procedures. The present disclosure may leverage existing metrics to quantify LoC. In other words, the present solution may use existing metrics to measure the impact of the energy saving opportunity on customer coverage (e.g., the extent of the LoC caused by the energy saving opportunity). Some of the existing metrics (e.g., KPIs) that are used by the present disclosure include, but are not limited to, customer level data, cell site data, sector data, market data, region data, national level data, and data associated with geographical hexagonal bins (e.g., geo hexbins or geo bins). In using these existing metrics, the present disclosure may understand how any of the four energy saving opportunities listed above (e.g., M-MIMO cell sleep, time-based cell sleep, traffic-based cell sleep, or intent-based cell sleep) influences LoC, as well as how these energy saving opportunities may be altered (e.g., mitigated) to reduce LoC caused by the energy saving opportunity.

Accordingly, the present disclosure does not blindly implement an energy saving opportunity without considering potential LoC associated with the energy saving opportunity (e.g., the present disclosure is aware of potential customer impacts in implementing an energy saving opportunity). In contrast to conventional methods, which often blindly utilize energy saving opportunities, the present disclosure may actively mitigate or avoid an energy saving opportunity that may be causing the LoC. To achieve this, the present disclosure may determine that there is LoC caused by an energy saving opportunity, and based on that determination, the present disclosure may respond in terms of field changes or compensation mechanisms that may affect coverage and the energy saving opportunity. As such, the present disclosure offers two solutions to LoC caused by an energy saving opportunity: (1) mitigation and (2) avoidance. By minimizing LoC for customers caused by an energy saving opportunity via mitigation (e.g., implementing a mitigation measure to affect the LoC) or avoidance (e.g., determining not to initiate the energy saving opportunity), the present disclosure may minimize customer churn.

Various components may be involved in the present disclosure. For illustrative purposes only, some of these components may include a base station that acts as the central hub (e.g., connected to the telecommunications network and a server) and is equipped with antennas to transmit and receive signals over a geographical area. User devices (UEs) located within the geographical coverage area may communicate wirelessly with the base station. Furthermore, the UEs may may communicate wirelessly with other devices inside or outside of the geographical coverage area.

The operational workflow for the present disclosure includes signal transmission from a base station to a number of UEs. The base station may emit radio signals that cover a defined service area. In other words, the base station includes one or more antenna elements that are configured to transmit one or more downlink signals from the base station to the one or more UEs located in a geographic coverage area. In some examples, these signals carry data to and from the internet. The UEs, equipped with respective antennas, receive these radio signals. At some point, an energy saving component initiates an energy saving opportunity. In some examples, the energy saving opportunity is a M-MIMO cell sleep, a time-based cell sleep, a traffic-based cell sleep, or an intent-based cell sleep. In some embodiments, the energy saving opportunity is implemented during a maintenance window.

In some aspects, the telecommunications network (or server) may receive one or more KPIs associated with a LoC caused by the energy saving opportunity. In some examples, the one or more KPIs comprises a failed paging message. In some embodiments, the telecommunications network may determine the energy saving opportunity caused the LoC based on the one or more KPIs. To determine that the energy saving opportunity caused the LoC, the telecommunications network may process PCMD associated with one or more UEs. Based on the PCMD, the telecommunications network may determine that the one or more KPIs associated with the LoC meets an operator defined threshold. By meeting the operator defined threshold, the telecommunications network may confirm that there is LoC. Furthermore, based on the one or more KPIs, telecommunications network may determine a geographic coverage area affected by the LoC. To determine the geographic coverage area affected by the LoC, telecommunications network may identify one or more geographical coverage areas (e.g., geographical hexagonal cells) targeted by the energy saving opportunity, and the telecommunications network may determine that the one or more geographical hexagonal cells are experiencing the LoC based on the operator defined threshold being met.

Moreover, the telecommunications network may implement a mitigation measure to mitigate the LoC affecting the geographic coverage area. In some examples, the mitigation measure is a recommendation to build a new cell site. In some examples, the mitigation measure involves utilizing neighbor tilt optimizations. In some examples, if the LoC exceeds the operator defined threshold, the cell site may be awakened (e.g., end the energy saving opportunity) to restore coverage. These approaches allow for a balance between energy saving and maintaining network coverage. By actively monitoring and responding to coverage loss, the present disclosure can optimize energy consumption while ensuring that customers do not experience significant disruptions in service. These approaches may help maintain customer satisfaction and reduces the likelihood of customer churn.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. Further, the term “some” may refer to “one or more.” Additionally, an element in the singular may refer to “one or more.”

The term “combination” (e.g., a combination thereof, combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

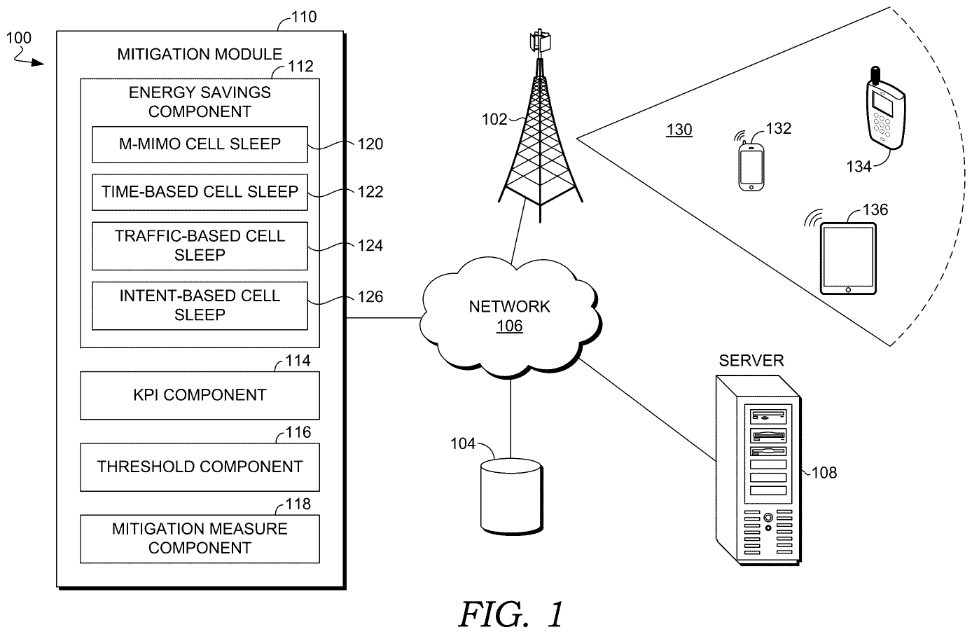

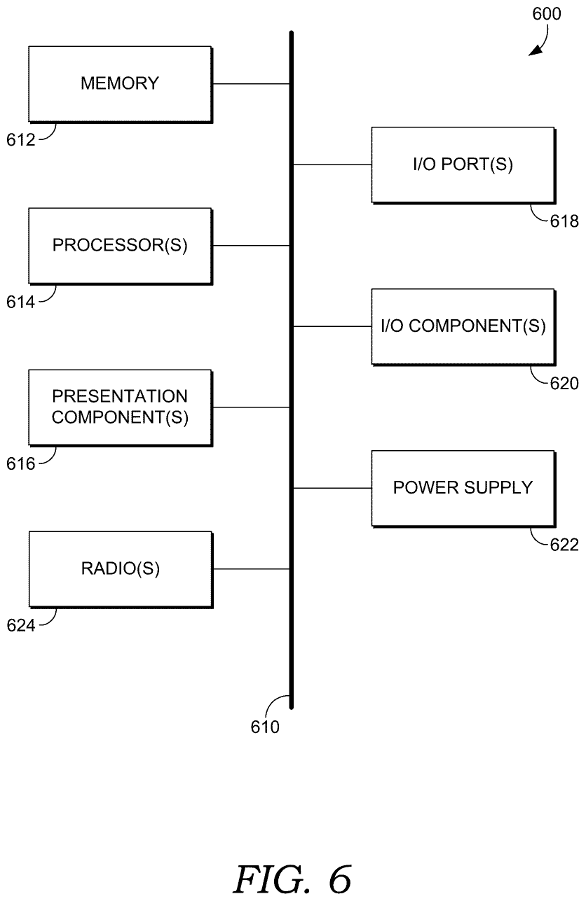

Additionally, a “user device,” as used herein, is a device that has the capability of using a wireless communications network, and may also be referred to as a “computing device,” “mobile device,” “user equipment,” “wireless communication device,” “device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to user devices 132, 134, or 136 described herein with respect to FIG. 1. A user device may also be, in another embodiment, similar to user device 600, described herein with respect to FIG. 6.

A user device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

In aspects, a user device discussed herein may be configured to communicate using one or more of 3G, 4G (e.g., LTE), 5G, 6G, another generation communication system, or one or more combinations thereof. In some aspects, the user device has a radio that connects with a 4G base station but is not capable of connecting with a higher generation communication system. In some aspects, the user device has components to establish a 5G connection with a 5G gNB, and to be served according to 5G over that connection. In some aspects, the user device may be an E-UTRAN New Radio-Dual Connectivity (ENDC) device. ENDC allows a user device to connect to an LTE eNB that acts as a master node and a 5G gNB that acts as a secondary node. As such, in these aspects, the ENDC device may access both LTE and 5G simultaneously, and in some cases, on the same spectrum band.

“Wireless telecommunication services” refer to the transfer of information without the use of an electrical conductor as the transferring medium. Wireless telecommunication services may be provided by one or more telecommunication network providers. Wireless telecommunication services may include, but are not limited to, the transfer of information via radio waves (e.g., Bluetooth®), satellite communication, infrared communication, microwave communication, Wi-Fi, mmWave communication, and mobile communication. Embodiments of the present technology may be used with different wireless telecommunication technologies or standards, including, but not limited to, CDMA 1xAdvanced, GPRS, Ev-DO, TDMA, GSM, WiMax technology, LTE, LTE Advanced, other technologies and standards, or one or more combinations thereof.

A “network” providing the wireless telecommunication services may be a telecommunication network(s), or a portion thereof. A telecommunication network might include an array of devices or components (e.g., one or more base stations). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a network can connect one or more user devices to a corresponding immediate service provider for services such as 5G and LTE, for example. In aspects, the network provides wireless telecommunication services comprising one or more of a voice service, a message service (e.g., SMS messages, MMS messages, instant messaging messages, an EMS service messages), a data service, other types of wireless telecommunication services, or one or more combinations thereof, to user devices or corresponding users that are registered or subscribed to a telecommunication service provider to utilize the one or more services. The network can comprise any communication network providing voice, message, or data service(s), such as, for example, a 1x circuit voice, a 3G network (e.g., CDMA, CDMA 2000, WCDMA, GSM, UMTS), a 4G network (WiMAX, LTE, HSDPA), a 5G network, a 6G network, another generation network, or one or more combinations thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay base stations, other network components, or one or more combinations thereof. The network may interface with one or more base stations through one or more wired or wireless backhauls. As such, the one or more base stations may communicate to devices via the network or directly. Furthermore, user devices can utilize the network to communicate with other devices (e.g., a user device(s), a server(s), etc.) through the one or more base stations.

As used herein, the term “base station” (used for providing UEs with access to the telecommunication services) or “node” generally refers to one or more base stations, nodes, RRUs control components, and the like (configured to provide a wireless interface between a wired network and a wirelessly connected user device). A base station may comprise one or more nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

For example, the base station may refer to a base transceiver station, a radio base station, an access point, a radio transceiver, a NodeB, an eNB, a gNB, a Home NodeB, a Home eNodeB, another type base station, or one or more combinations thereof. A node corresponding to the base station may comprise one or more of a macro base station, a small cell or femtocell base station, a relay base station, another type of base station, or one or more combinations thereof. In aspects, the base station may be configured as FD-MIMO, massive MIMO, MU-MIMO, cooperative MIMO, 3G, 4G, 5G, another generation communication system, or one or more combinations thereof. In addition, the base station may operate in an extremely high frequency region of the spectrum (e.g., from 30 GHz to 300 GHz), also known as the millimeter band.

Aspects of the technology described herein may be embodied as, among other things, a method, system, or computer-program product. Accordingly, aspects may take the form of a hardware embodiment, or an aspect combining software and hardware. An aspect that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

In a first aspect, a method is provided for mitigating LoC associated with an energy saving opportunity. The method includes initiating the energy saving opportunity, receiving one or more KPIs associated with the LoC caused by the energy saving opportunity, and, based on the one or more KPIs, determining a geographic coverage area affected by the LoC. The method further includes implementing a mitigation measure to mitigate the LoC affecting the geographic coverage area.

In a second aspect, a system is provided for mitigating LoC associated with an energy saving opportunity. The system includes one or more antenna elements configured to transmit one or more downlink signals from a base station to one or more UEs located in a geographic coverage area, and one or more computer processing components that are configured to perform operations. The operations comprise initiating the energy saving opportunity. The operations further comprise receiving a failed paging message, wherein the failed paging message is associated with the LoC caused by the energy saving opportunity. The operations further comprise based on receiving the failed paging message, determining a geographic coverage area affected by the LoC. The operations further comprise implementing a tilt on a neighboring cell site. The operations further comprise implementing a mitigation measure to mitigate the LoC affecting the geographic coverage area, wherein the mitigation measure is an adjustment to the energy saving opportunity.

In a third aspect, one or more non-transitory computer storage media storing instructions that when executed via one or more processors perform a computerized method for mitigating LoC associated with an energy saving opportunity. The method includes initiating the energy saving opportunity. The method further includes receiving a failed paging message, wherein the failed paging message is associated with the LoC caused by the energy saving opportunity. The method further includes based on receiving the failed paging message, determining a geographic coverage area affected by the LoC. The method further includes implementing a tilt on a neighboring cell site. The method further includes implementing a mitigation measure to mitigate the LoC affecting the geographic coverage area, wherein the mitigation measure is recommending construction of a new cell site.

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement to any one or combination of components illustrated.

More specifically, FIG. 1 depicts a system for mitigating loss of coverage (LoC) associated with an energy saving opportunity. The system includes components and interactions between UEs (e.g., a first UE 132, a second UE 134, and up to an Nth UE 136) and a base station to initiate an energy saving opportunity, gather device-specific information (e.g., PCMD), determine there is LoC within a geographic coverage area, and implement a mitigation measure to mitigate the LoC. Network environment 100 includes base station 102 (e.g., a base station), one or more UEs (e.g., the first UE 132, the second UE 134, and up to the Nth UE 136), a database 104, a network 106, a server 108, and a mitigation module 110.

As mentioned, network environment 100 includes one or more UEs (e.g., the first UE 132, the second UE 134, and up to the Nth UE 136). In network environment 100, the UEs may take on multiple forms, such as smartphones, tablets, computers, to name a few, or any other device (such as the computing device 600) that communicates via wireless communications with the base station 102 in order to interact with a public or private network. The network environment 100 comprises one or more base stations with which a UE may wirelessly communicate. The base station 102 may be associated with one or more at least partially distinct networks, such as the network 106, wherein each network is associated with one or more network identifiers.

In some examples, the network 106 may comprise a database 104. In some embodiments, the database 104 is a standalone database that is used by a mitigation module 110 to mitigate LoC associated with an energy saving opportunity. In some aspects, the database 104 may be a database that is shared with other systems to accomplish more tasks within the scope of this disclosure and/or outside the scope of this disclosure. In some embodiments, PCMD associated with the one or more UEs located within a certain geographic region (e.g., the geographic coverage area 130) may be stored in the database 104. In some examples, the PCMD may include the signal strength, bandwidth capacities, latency, connectivity effectiveness, interference events, and drop rates associated with UEs in the geographic coverage area 130.

In order to mitigate LoC associated with an energy saving opportunity, the network environment 100 comprises the mitigation module 110. Though illustrated as a dedicated module comprising four discrete components, the mitigation module 110 and its components are described herein by way of their functionality and may be deployed or implemented in various ways that are consistent with the functionality described herein. For example, the mitigation module 110 may take the form of one or more computer processing components at or near the base station 102 executing computer executable instructions that cause the one or more computer processing components to perform the operations described herein. The mitigation module 110 may be said to comprise an energy saving component 112, a KPI component 114, a threshold component 116 and a mitigation measure component 118.

The energy saving component 112 is configured to initiate an energy saving opportunity. For instance, the energy saving component 112 may employ conventional energy saving opportunities, such as cell sleep. For example, the energy saving component 112 initiates one of four separate cell sleep methods: M-MIMO cell sleep 120, time-based cell sleep 122, traffic-based cell sleep 124, and intent-based cell sleep 126. In addition to these cell sleep methods, the energy saving component 112 may also utilize a scheduler level power allocation that can be used as an energy saving opportunity.

In some examples, the M-MIMO cell sleep 120 involves selectively determining which M-MIMO radios (e.g., associated with the base station 102) to put to sleep to yield power savings. For example, the M-MIMO cell sleep 120 may involve using only half of the M-MIMO (e.g., half of the M-MIMO is “asleep”). To illustrate with an example, if the M-MIMO is associated with 64 transmit and receive (TRx), the TRx can be halved to 32 TRx. However, when a cell site is not using all its antenna elements (e.g., when the M-MIMO cell sleep 120 is initiated), then the coverage of a geographic coverage area (e.g., the geographic coverage area 130) necessarily changes. The coverage may be negatively impacted (e.g., LoC may exist), because the geographic coverage area that the is affected by the base station serving that area is affected by the M-MIMO cell sleep 120. In some examples, KPIs received by the network associated with the M-MIMO cell sleep 120 make it evident that users are experiencing LoC when the M-MIMO cell sleep 120 is initiated. In some embodiments, to limit the effect of the M-MIMO cell sleep 120, the M-MIMO cell sleep 120 may be implemented during a maintenance window period (e.g., a scheduled timeframe during which planned maintenance activities, such as updates, upgrades, or repairs, are performed on the network).

In some examples, the time-based cell sleep 122 involves implementing a maintenance window period during a specified time period (e.g., an adjustable time period) in which network traffic tends to be low. For example, midnight to 6 am could be the maintenance window period. The timing of the maintenance window may be based on the typical behavior of users in a geographically defined area (e.g., the geographic coverage area 130). For example, if people in a specific geographic region tend to stop using network functions around 10 pm and begin to use them again around 5 am, then that time period could be designated as the maintenance window. As such, the time-based cell sleep 122 approach may not be the same for distinct regions. During the time-based cell sleep 122, radio functions may be reduced (e.g., turned off) such that power expenditure may be saved. With the time-based cell sleep 122, the network 106 is essentially employing a sleep window (e.g., the maintenance window). The network 106 may be awake for some time before and after the sleep window occurs. If there are a certain number of users (e.g., a threshold amount) utilizing network functions during the maintenance window, then the network 106 may not go to sleep (e.g., the time-based cell sleep 122 may not be initiated). If there are less users than the amount required to keep the network awake, then the network may go to sleep during the maintenance window (e.g., the time-based cell sleep 122 may be initiated). In some examples, preparing the network 106 to sleep during the maintenance window requires power. Here, because it is presumed that customers are not requiring network services during the maintenance window, some customers experience LoC as the telecommunications network seeks to save energy by employing the time-based cell sleep 122.

In some examples, the traffic-based cell sleep 124 accounts for the traffic of users (e.g., movement of users from one geographic coverage area to another), and, based on this traffic, the network 106 may turn off selected radio functions (e.g., initiate the traffic-based cell sleep 124) in one geographic coverage area as the traffic shifts to another area. Here, the network 106 tries to determine that traffic is below a certain threshold level in one area based on this shifting of users from one location to the next. If traffic is below that certain threshold level, then the network 106 may initiate the traffic-based cell sleep 124. For example, if there is a low traffic load, the network 106 may shut down some of its layers (e.g., types of frequencies, such as macro or micro). To illustrate with an example, if a geographic coverage area is determined to have a low traffic load, two layers may be turned off to save energy. In this example, a coverage layer may nonetheless stay on (e.g., is always on) to serve customers. Here, if there is only one coverage layer and there is enough bandwidth (e.g., not too many customers), then the network 106 may offer minimal DL/UL speeds to customers. If there is not enough bandwidth, then a layer may be added back to help serve customers (e.g., go from a low traffic load to a medium traffic load). Instead of turning on/off layers (e.g., of frequencies), the traffic-based cell sleep 124 may be initiated by tilting the antennas of the cell site (e.g., the base station 102). For example, if carriers are hosted on different radios, each cell site may have its own tilt. Here, if one of the cell sites is tilted down (e.g., lower), then the cell site that is sleeping (e.g., the traffic-based cell sleep 124 has been initiated), but if it is tilted up (e.g., higher), then that cell site is awake (e.g., the traffic-based cell sleep 124 has not been initiated). For the users that are in the geographic coverage area where the cell site is tilted down, they might not be receiving a signal from that cell site anymore, leading to LoC. For example, if the network 106 believed that there were ten customers in a geographic coverage area when the network 106 shut down one of the layers (e.g., the tilt of a cell site went down), but there were in fact eleven customers in total, then that one customer in the geographic coverage area serviced by the cell site that went down will likely experience LoC.

In some examples, the intent-based cell sleep 126 involves maintaining DL/UL speeds for customers based on the devices connected to a home internet (e.g., router). For example, intent-based cell sleep 126 may provide a certain amount of speed (e.g., 25 megabits) for a household during certain times to maximize customer satisfaction while saving power (e.g., employing the intent-based cell sleep) when the power expenditure is not needed (e.g., based on a pattern of time and/or traffic usage of power in the household).

Based on these four energy saving opportunities (e.g., the M-MIMO cell sleep 120, the time-based cell sleep 122, the traffic-based cell sleep 124, and the intent-based cell sleep 126), which are related to the radio aspect of a cell site, telecommunication networks have been able to save power regarding OpEx. These energy saving opportunities can be implemented within specific layers (e.g., types of frequencies, like macro or micro) or specific geographic regions (e.g., serviced by specific cell sites). However, conventional telecommunications networks employing these energy saving opportunities often assume that their power saving methods do not have a substantial impact on coverage. This assumption, however, often leads to LoC for certain customers located in the geographic coverage areas where the energy saving opportunities are being utilized.

The KPI component 114 processes KPIs, including PCMD associated with the one or more UEs, that may be indicative of LoC in real-time or near real-time. For example, the KPI component 114 may process customer level data, cell site data, sector data, market data, region data, national level data, and data associated with geographical hexagonal bins (e.g., geo hexbins or geo bins). In some examples, the one or more KPIs comprise a failed paging message. The information (e.g., data) processed by the KPI component 114 may be gathered by the base station 102, network 106, or server 108 and may be stored in the database 104. In some embodiments, the mitigation module 110 may determine the energy saving opportunity caused the LoC based on the one or more KPIs processed by the KPI component 114.

The threshold component 116 utilizes the KPIs and PCMD processed by the KPI component 114 to determine that one or more KPIs associated with the LoC meets an operator defined threshold. By meeting the operator defined threshold, the threshold component 116 may confirm that there is LoC. Furthermore, based on the one or more KPIs, the threshold component 116 may determine a geographic coverage area affected by the LoC (e.g, the geographic coverage area 130). To determine the geographic coverage area affected by the LoC, the threshold component 116 may identify the geographic coverage area (e.g., one or more geographical hexagonal cells) targeted by the energy saving opportunity, and the threshold component 116 may determine that the geographic coverage area is experiencing the LoC based on the operator defined threshold being met.

The mitigation measure component 118 implements a mitigation measure to mitigate the LoC affecting the geographic coverage area. In some examples, the mitigation measure component 118 may recommend that a new cell site be built to ameliorate the LoC (e.g., restore coverage). In some examples, the mitigation measure component 118 may utilize neighbor tilt optimizations to ameliorate the LoC. In some examples, when the LoC exceeds the operator defined threshold, the mitigation measure component 118 may awaken the cell cite (e.g., end the energy saving opportunity) affected by the LoC to restore coverage.

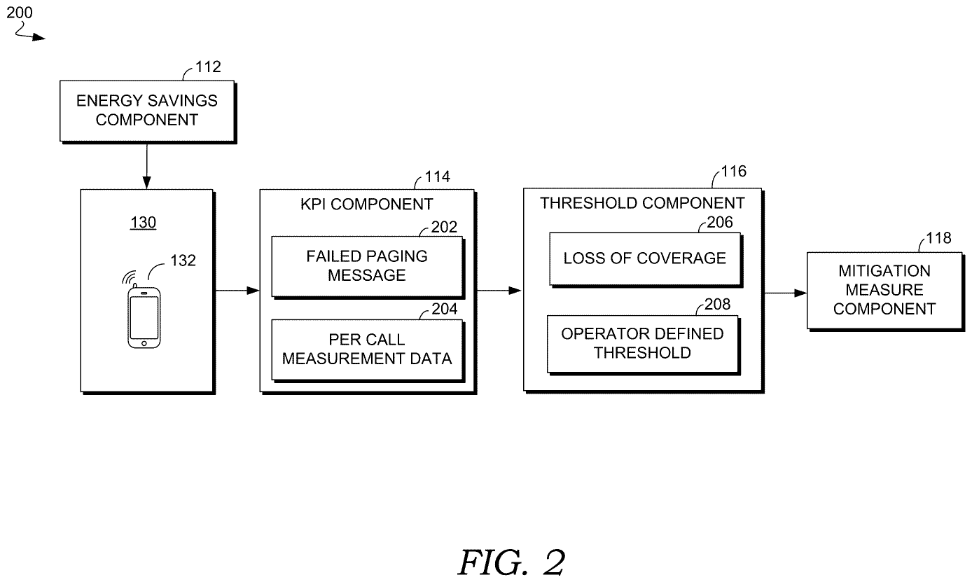

With reference now to FIG. 2, FIG. 2 illustrates an example flowchart of a mitigation environment 200 employing the mitigation module 110 to mitigate LoC associated with an energy saving opportunity, in accordance with aspects herein. As can be seen in the example depicted in FIG. 2, the energy saving component 112 may initiate an energy saving opportunity (e.g., the M-MIMO cell sleep 120, the time-based cell sleep 122, the traffic-based cell sleep 124, or intent-based cell sleep 126) via a base station (e.g., the base station 102) over a coverage area (e.g., the geographic coverage area 130). UEs located within that coverage area, such as the first UE 132, may be affected by the energy saving opportunity. According to some examples, the KPI component 114 may collect one or more KPIs associated with a LoC, such as a failed paging message 202 and PCMD 204. Based on the one or more KPIs, the threshold component 116 may determine that the one or more KPIs meets an operator defined threshold 208, meaning that a LoC 206 is associated with the energy saving opportunity (e.g., the energy saving opportunity caused the LoC). Furthermore, the threshold component 116 may determine the geographic coverage area 130 may be affected by the LoC 206. Once it is determined that the geographic coverage area 130 may be affected by the LoC 206, the mitigation measure component 118 may implement a mitigation measure to mitigate the LoC affecting the geographic coverage area 130.

In some examples, once the energy saving opportunity is initiated by the energy saving component 112, there may be a number of UEs (e.g., the first UE 132) in the geographical coverage area 130 that are offloaded by the network. In some examples, if the UE is not active at the time the energy saving opportunity is initiated by the energy saving component 112, then that UE may be ignored by conventional methods. For example, according to conventional methods, if a UE is not active and the cell site goes to sleep, when the UE receives an incoming call, the UE may not be reachable, unless the user associated with the UE does something manually, such as locking a band or restarting the UE to go to a different band. Otherwise, the user likely will not receive service until the sleep mode is turned off (e.g., wake up conditions are met).

In some embodiments, the RAN nodes associated with the base station servicing the geographical coverage area 130 may stream PCMD 204 into the network's servers (e.g., the server 108). In some aspects, the KPI component 114 processes the PCMD 204 for data analytics. For example, the PCMD 204 may include the most relevant data regarding how users located in the geographical coverage area 130 are using data (e.g., if they are using data), such as making wireless calls or engaging in a particular data session, as well as the session duration. In some embodiments, the KPI component 114 leverages the PCMD 204 by selecting a procedure ID for each session (e.g., each occurrence of the PCMD 204). For example, there can be N number of call flows happening on a particular UE, and each call flow may be given a procedure ID. For instance, the KPI component 114 may assign each message a specific procedure ID. In some examples, the KPI component 114 may define a LoC as something that starts with a failed paging message 202, including page deceptions that are happening on the downlink. For example, the network may try to send a pending message to the first UE 132 in the geographical coverage area 130. Here, while there can be several reasons why the first UE 132 is unavailable, the network may generally notice that the first UE 132 is not available (e.g., the user associated with the first UE 132 cannot receive the message that the network is trying to send). Notably, this failed paging message 202 is a signature of LoC.

To determine whether there is a genuine LoC (e.g., as compared to the network just interrupting itself), the threshold component 116 may analyze the network message that comes back (e.g., a restore coverage metric). In other words, the threshold component 116 may analyze the response message that returns after the network tries to send a message to the first UE 132 (e.g., an attempt by the network to reach a customer; a failed paging message can happen in any scenario in which the network has reached out to a customer, such as the customer receiving an incoming call, the customer receiving a WhatsApp ping message or an SMS, the customer is downloading something from YouTube, etc.). For example, messages that indicate that coverage should be restored (e.g., there is likely LoC) may include, but are not limited to, an identification request, a detach request from the first UE 132, a tracking area update (TAU) message, a UE requested bearer modification, and any other message (e.g., a PCMD procedure ID) that can be considered a “restore coverage” message. For example, a TAU message may tell the network that the first UE 132 is switching between tracking areas, which means that the user associated with the first UE 132 is not stationary, but rather moving around. Here, the TAU message can be an indication of LoC. This indication of LoC may be determined by the KPI component 114, and the threshold component 116 may receive this indication of the LoC from the KPI component 114 to make two decisions: (1) did the first UE 132 lose coverage (e.g., based on the failed paging message 202 received by the network, yes, the user associated with the first UE 132 likely lost coverage) and (2) if so, how long did the user lose the coverage (e.g., the time of LoC can range, anywhere from one second to hours).

In some examples, the duration of time that the first UE 132 has lost coverage is an aspect of the operator defined threshold 208 (e.g., adjustable by an operator). For example, the operator defined threshold 208 can be satisfied as follows: whenever there is an energy saving opportunity implemented for an X duration, and a user experiences LoC for a Y duration, which can be the same as the X duration or a predefined time period smaller than the X duration, then the threshold component 116 may determine that the operator defined threshold 208 has been met. In addition, if the first UE 132 does not send any handover messages, meaning that there is no mobility from the user (e.g., connected to a fixed wireless residential (FWR) home internet does not move anywhere, it is stationary), then the LoC 206 may coincide with the trigger of energy saving opportunity initiated by the energy saving component 112. Here, based on the operator defined threshold 208 being met, the threshold component 116 may determine that the LoC 206 exists for at least some UEs located within the geographic coverage area 130 based at least in part on the energy saving opportunity initiated by the energy saving component 112.

In some examples, the threshold component 116 may utilize the PCMD 204 processed by the KPI component 114 to determine that the LoC 206 exists. For example, the PCMD 204 may be gathered per call (e.g., made by the first UE 132), and each call may be associated with a single user (e.g., the user that operates the first UE 132). Here, the KPI component 114 may process the PCMD 204 at the customer level, allowing the threshold component 116 to determine specifically how many users are affected by the LoC 206. Furthermore, the duration of how long the average customer experiences the LoC 206 (e.g., 120 seconds) can be used by the threshold component 116 as part of the operator defined threshold 208, the number of customers (e.g., 20 customers) experiencing the LoC 206 can be used as part of the operator defined threshold 208, and/or a combination of duration and number of customers can be used as part of the operator defined threshold 208. Based on the threshold component 116 determining that the LoC 206 exists (e.g., the operator defined threshold 208 has been met), the mitigation measure component 118 may implement a mitigation measure to mitigate the LoC 206.

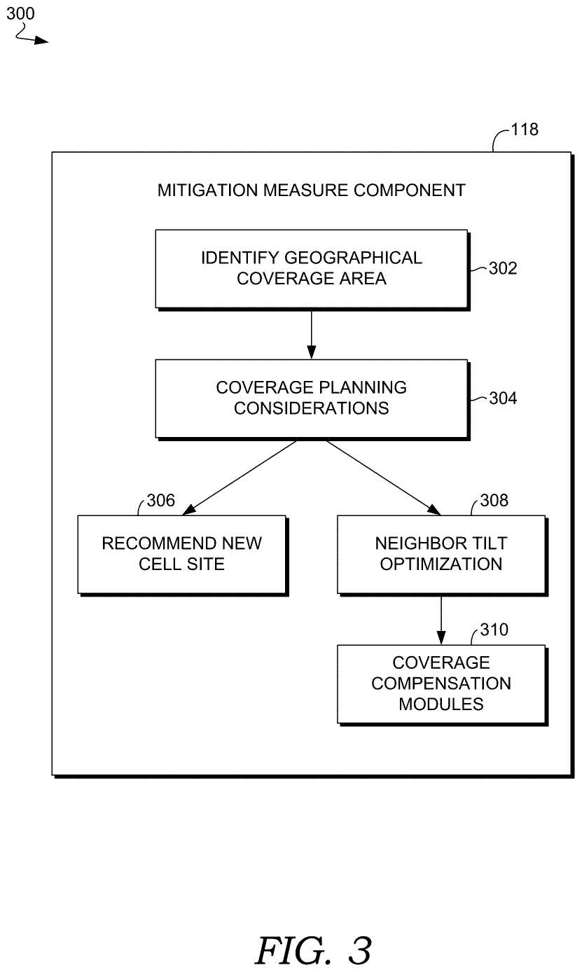

Turning now to FIG. 3, FIG. 3 illustrates an example flowchart of the mitigation measure component 118 mitigating LoC associated with an energy saving opportunity, in accordance with aspects herein. In some aspects, the mitigation measure component 118 may either seek to avoid future occurrences of the LoC associated with an energy saving opportunity or actively mitigate the LoC. For example, the mitigation measure component 118 may recommend that the energy saving opportunity does not occur again in the future to avoid the LoC associated with the energy saving opportunity. In some embodiments, the mitigation measure component 118 may implement one of two options to mitigate active (e.g., contemporary) and/or future LoC associated with the energy saving opportunity: (1) recommend a new cell site 306 or (2) utilize a neighbor tilt optimization 308. To achieve this, the mitigation measure component 118 may determine that there is LoC caused by an energy saving opportunity, and based on that determination, the present disclosure may respond in terms of field changes or compensation mechanisms that may affect coverage and the energy saving opportunity. Accordingly, the mitigation measure component 118 may identify a geographical coverage area 302 associated with the LoC and make coverage planning considerations 304.

In some embodiments, based on the LoC (e.g., the LoC 206) determined for a geographic coverage area (e.g., the geographic coverage area 130) as determined by the threshold component 116 (e.g., as illustrated in the description of FIG. 2), the mitigation measure component 118 may identify the geographic coverage area 302 associated with the LoC. In some examples, when the mitigation measure component 118 identifies a geographical coverage area 302 where LoC associated with an energy saving opportunity exists, then mitigation measure component 118 may identify the number of users who are being impacted (e.g., determined by the threshold component 116 based on the PCMD for the individual users within the geographical coverage area 130). In some aspects, the mitigation measure component 118 may use the number of users who are being affected by the LoC in the coverage planning considerations 304. In some embodiments, the coverage planning considerations 304 may include two options: (1) recommend a new cell site 306 or (2) utilize a neighbor tilt optimization 308. In some examples, these two options are mutually exclusive from one another. In other examples, these two options may be used concurrently. For example, if utilizing a neighbor tilt optimization 308 does not sufficiently restore coverage to the geographical coverage area affected by the LoC, the mitigation measure component 118 may then recommend building a new cell site 306.

In some examples, if the LoC effects a high number of users, meaning that a significant amount of users in the geographical coverage area (e.g., in a geographical hexagonal bin) are experiencing LoC, then building a new cell site might be advantageous. As such, in this scenario, the mitigation measure component 118 may recommend a new cell site 306 be built. In doing so, the mitigation measure component 118 may store the recommendation in the database 104 for later retrieval by an operator, or the mitigation measure component 118 may cause the recommendation to be displayed on a display device for an operator to view.

In some embodiments, once the mitigation measure component 118 receives the coverage area being affected by the LoC from the threshold component 116, the mitigation measure component 118 may utilize neighbor tilt optimization 308. For example, when there is an energy saving opportunity being employed on a particular site (e.g., a geographic coverage area) that is causing LoC at that particular site, then a tilt adjustment to the base station servicing that site (or a tilt adjustment to neighboring base stations) may be implemented by the mitigation measure component 118 such that the base station (or the neighboring base stations) covers the geographic area experiencing the LoC. For instance, the mitigation measure component 118 may utilize a known coverage compensation module 310 to determine the base stations neighboring the base station servicing the geographic coverage area experiencing the LoC (e.g., the base station employing the energy saving opportunity causing the LoC), and the mitigation measure component 118 may utilize the coverage compensation module 310 to adjust the tilts of the neighboring base stations to fill in the coverage hole (e.g., restore the coverage of the geographic coverage area). Here, the mitigation measure component 118 may maintain the energy saving opportunity wile mitigating the LoC that the mitigation module 110 was able to identify and correlate with the energy saving opportunity. In other words, if there is LoC that is correlated with an energy saving opportunity initiated during a maintenance window, then neighbor sites (or even the same sites) can implement a tilt change to cover the geographical coverage area while the energy saving opportunity continues to be employed.

In some examples, when the threshold component 116 determines that the LoC is greater than the operator defined threshold, then the mitigation measure component 118 may fully awaken the cell from its cell sleep (e.g., the energy saving opportunity). Thus, the mitigation measure component 118 may utilize the LoC as a threshold. For example, the mitigation measure component 118 may identify how many people in the geographic coverage area that are being affected by the LoC (e.g., determined by the threshold component 116), and then the mitigation measure component 118 may determine whether to fully awaken the cell or to partially awaken the cell. For instance, if few users in the geographic overage area are affected by the LoC caused by the energy saving opportunity, then the mitigation measure component 118 may choose to partially awake, or to not awake the cell at all, because the goal of the energy saving opportunity may be to save a certain amount power (e.g., a threshold amount that is configurable) and not servicing those few users by employing the energy saving opportunity may achieve this goal. However, the equation changes when there are many users experiencing the LoC. Here, when there are many users experiencing the LoC, the mitigation measure component 118 many fully awaken, or partially awaken, the cell from the cell sleep. Whether a cell is fully awakened or partially awakened by the mitigation measure component 118 may depend on the number of users experiencing the cell sleep.

Overall, the mitigation measure component 118 of the mitigation module 110 may lessen the extent of the LoC associated with the energy saving opportunity. In one embodiment, if the geographic coverage area is small, and the intensity of the LoC is small (e.g., a low number of users are affected by the LoC), then the first choice of the mitigation measure component 118 may be to leverage tilting to determine if the energy saving opportunity may continue to be employed to optimize energy saving without having to specifically change the energy saving method. Here, the mitigation measure component 118 may utilize the neighbor tilt optimization 308 for some time T; if the tilt resolves the LoC, then the mitigation measure component 118 may not make any adjustments to the energy saving opportunity (e.g., may not awaken the cell), but if the tilt does not resolve the LoC during time T, then the mitigation measure component 118 may make an adjustment to the energy saving opportunity (e.g., may awaken the cell). In one embodiment, if the geographic coverage area is large, and the intensity of the LoC is large (e.g., a high number of users are affected by the LoC), then the mitigation measure component 118 may either recommend a new cell site 306 or utilize the neighbor tilt optimization 308. If the mitigation measure component 118 utilizes the neighbor tilt optimization 308, and the tilt does not resolve the LoC, then the mitigation measure component 118 may step down the energy saving (e.g., fully or partially awaken the cell). However, if the LoC is still greater than an acceptable amount, then the mitigation measure component 118 may recommend a new cell site 306.

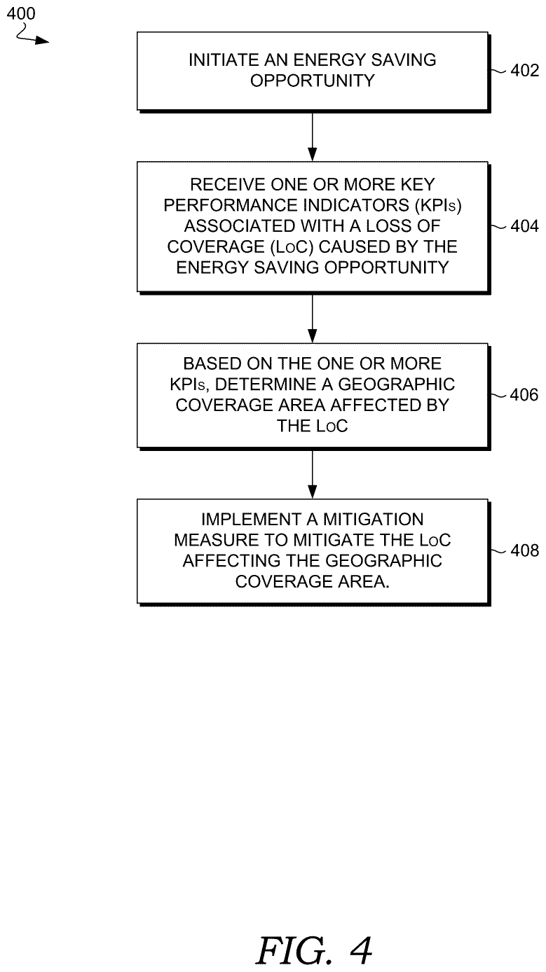

With reference now to FIG. 4, FIG. 4 illustrates an example flowchart of a method 400 for mitigating LoC associated with an energy saving opportunity, in accordance with aspects herein. At block 402, an energy saving opportunity is initiated. For example, the energy saving opportunity may include M-MIMO cell sleep, time-based cell sleep, traffic-based cell sleep, and intent-based cell sleep. Each of these cell sleep methods aims to reduce energy consumption on the RAN by selectively putting certain radio functions to sleep or adjusting power levels based on specific criteria. For example, M-MIMO cell sleep may involve halving the number of active transmit and receive antennas, while time-based cell sleep may be scheduled during periods of low network traffic, such as midnight to early morning hours.

At block 404, one or more KPIs associated with a LoC caused by the energy saving opportunity is received. Once the energy saving opportunity is initiated, the mitigation module 110 of the present disclosure may monitor the network for any LoC that may result from the energy saving opportunity being employed. This involves receiving KPIs that indicate LoC, such as failed paging messages or per call measurement data (PCMD). These KPIs provide real-time or near real-time data on network performance and user experience, allowing the mitigation module 110 to detect when and where coverage is lost due to the energy saving opportunity.

At block 406, a geographic coverage area affected by the LoC is determined based on the one or more KPIs. Using the received KPIs, the mitigation module 110 may determine the geographic coverage area affected by the LoC. This involves the mitigation module 110 analyzing the data associated with the KPIs to identify specific regions or cells where coverage has been compromised. In some examples, the mitigation module 110 may use geographical hexagonal bins or other spatial data structures to map out the affected areas. To determine the geographical area affected by the LoC, the mitigation module 110 may compare the KPIs against an operator defined thresholds to confirm the extent and location of the LoC.

At block 408, a mitigation measure to mitigate the LoC affecting the geographic coverage area is implemented. In other words, the mitigation module 110 may implement mitigation measures to address the LoC in the affected geographic coverage area. These mitigation measures can include adjusting the tilt of neighboring cell sites to improve coverage, recommending the construction of new cell sites, or waking up cells that were put to sleep. In some examples, the mitigation measures are selected based on the severity of the LoC and the number of users impacted, ensuring that customer satisfaction is preserved while optimizing energy consumption.

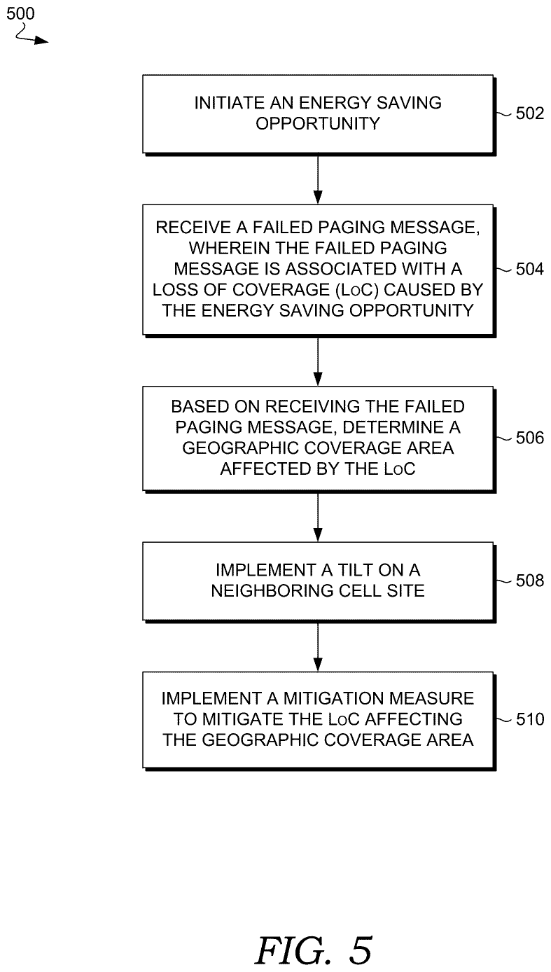

FIG. 5 illustrates another example flowchart of a method 500 mitigating LoC associated with an energy saving opportunity in accordance with aspects herein. At block 502, an energy saving opportunity is initiated. For example, the energy saving opportunity may include M-MIMO cell sleep, time-based cell sleep, traffic-based cell sleep, and intent-based cell sleep. Each of these cell sleep methods aims to reduce energy consumption on the RAN by selectively putting certain radio functions to sleep or adjusting power levels based on specific criteria. For example, M-MIMO cell sleep may involve halving the number of active transmit and receive antennas, while time-based cell sleep may be scheduled during periods of low network traffic, such as midnight to early morning hours.

At block 504, a failed paging message associated with a LoC caused by the energy savings opportunity is received. Once the energy saving opportunity is initiated, the mitigation module 110 may monitor the network for any loss of coverage (LoC) that may result. This involves receiving failed paging messages, which are indicative of LoC. A failed paging message occurs when the network attempts to send a message to a user device, but the device does not respond (or does not respond within a reasonable timeframe), indicating that the user device is not reachable. This failed paging message can be directly associated with the energy saving opportunity that has been implemented.

At block 506, a geographic coverage area affected by the LoC is determined based receiving the failed paging message. Using the received failed paging message, the mitigation module 110 may determine the geographic coverage area affected by the LoC. This involves analyzing the data associated with the failed paging message (as well as PCMD) to identify specific regions or cells where coverage has been compromised. The mitigation module 110 may use geographical hexagonal bins or other spatial data structures to map out the affected areas. The determination process may include comparing the time it takes for a failed paging message to be received by the network in response to sending a message against an operator defined threshold to confirm the extent and location of the LoC.

At block 508, a tilt on a neighboring cell site is implemented. In other words, to mitigate the LoC, the mitigation module 110 may implement a tilt adjustment on neighboring cell sites. This involves adjusting the angle of the antennas on neighboring cell sites to improve coverage in the affected geographic area. By optimizing the tilt, the system can redirect signal strength to areas experiencing LoC to enhance coverage in the affected area.

At block 510, a mitigation measure to mitigate the LoC affecting the geographic coverage area is implemented. In other words, if the initial neighbor tilt optimization technique does not improve the LoC, the mitigation module may implement additional mitigation measures to address the LoC in the affected geographic coverage area. These measures can include further adjustments to the tilt of neighboring cell sites, recommending the construction of new cell sites, or waking up cells that were put to sleep. The mitigation measures may be selected by the mitigation module 110 based on the severity of the LoC and the number of users impacted, ensuring that customer satisfaction is preserved while optimizing energy consumption.

Having described the example embodiments discussed above of the presently disclosed technology, an example operating environment of an example user device (e.g., any of user devices 132, 134, and 136 of FIG. 1) is described below with respect to FIG. 6. User device 600 is but one example of a suitable computing environment and is not intended to suggest any particular limitation as to the scope of use or functionality of the technology disclosed. Neither should user device 600 be interpreted as having any dependency or requirement relating to any particular component illustrated, or a particular combination of the components illustrated in FIG. 6.

As illustrated in FIG. 6, example user device 600 includes a bus 610 that directly or indirectly couples the following devices: memory 612, one or more processors 614, one or more presentation components 616, one or more input/output (I/O) ports 618, one or more I/O components 620, a power supply 622, and one or more radios 624.

Bus 610 represents what may be one or more busses (such as an address bus, data bus, or combination thereof). Although the various blocks of FIG. 6 are shown with lines for the sake of clarity, in reality, these blocks represent logical, not necessarily actual, components. For example, one may consider a presentation component, such as a display device, to be an I/O component. Also, processors have memory. Accordingly, FIG. 6 is merely illustrative of an exemplary user device that can be used in connection with one or more embodiments of the technology disclosed herein.

User device 600 can include a variety of computer-readable media. Computer-readable media can be any available media that can be accessed by user device 600 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 612 includes computer storage media in the form of volatile and/or nonvolatile memory. The memory 612 may be removable, non-removable, or a combination thereof. Example hardware devices of memory 612 may include solid-state memory, hard drives, optical-disc drives, other hardware, or one or more combinations thereof. As indicated above, the computer storage media of the memory 612 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 600, or one or more combinations thereof.

The one or more processors 614 of user device 600 can read data from various entities, such as the memory 612 or the I/O component(s) 620. The one or more processors 614 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 614 can execute instructions, for example, of an operating system of the user device 600 or of one or more suitable applications.

The one or more presentation components 616 can present data indications via user device 600, another user device, or a combination thereof. Example presentation components 616 may include a display device, speaker, printing component, vibrating component, another type of presentation component, or one or more combinations thereof. In some embodiments, the one or more presentation components 616 may comprise one or more applications or services on a user device, across a plurality of user devices, or in the cloud. The one or more presentation components 616 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof. For example, the one or more presentation components 616 can present a visualization that compares a plurality of inspections of one or more cores of a central processing unit and a visualization of each task of each of the plurality of inspections.

The one or more I/O ports 618 allow user device 600 to be logically coupled to other devices, including the one or more I/O components 620, some of which may be built in. Example I/O components 620 can include a microphone, joystick, game pad, satellite dish, scanner, printer, wireless device, and the like. The one or more I/O components 620 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 616 on the user device 600. In some embodiments, the user device 600 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 600 may, additionally or alternatively, be equipped with accelerometers or gyroscopes that enable detection of motion. In some embodiments, the output of the accelerometers or gyroscopes may be provided to the one or more presentation components 616 of the user device 600 to render immersive augmented reality or virtual reality.

The power supply 622 of user device 600 may be implemented as one or more batteries or another power source for providing power to components of the user device 600. In embodiments, the power supply 622 can include an external power supply, such as an AC adapter or a powered docking cradle that supplements or recharges the one or more batteries. In aspects, the external power supply can override one or more batteries or another type of power source located within the user device 600.

Some embodiments of user device 600 may include one or more radios 624 (or similar wireless communication components). The one or more radios 624 can transmit, receive, or both transmit and receive signals for wireless communications. In embodiments, the user device 600 may be a wireless terminal adapted to receive communications and media over various wireless networks. User device 600 may communicate using the one or more radios 624 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 624 may facilitate communication via radio frequency signals, frames, blocks, transmission streams, packets, messages, data items, data, another type of wireless communication, or one or more combinations thereof. The one or more radios 624 may be capable of transmitting, receiving, or both transmitting and receiving wireless communications via mmWaves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for mitigating loss of coverage (LoC) associated with an energy saving opportunity, the method comprising:
initiating the energy saving opportunity;
receiving one or more key performance indicators (KPIs) associated with the LoC caused by the energy saving opportunity;
based on the one or more KPIs, determining a geographic coverage area affected by the LoC; and
implementing a mitigation measure to mitigate the LoC affecting the geographic coverage area.

2. The method of claim 1, wherein the energy saving opportunity is a massive multiple-input multiple-out (M-MIMO) cell sleep, a time-based cell sleep, a traffic-based cell sleep, or an intent-based cell sleep.

3. The method of claim 2, wherein the energy saving opportunity is implemented during a maintenance window.
The method of claim 1, wherein the one or more KPIs comprises a failed paging message.

5. The method of claim 1, further comprising determining the energy saving opportunity caused the LoC based on the one or more KPIs, wherein determining the energy saving opportunity caused the LoC comprises:
processing per call measurement data (PCMD); and
based on the PCMD, determining that the one or more KPIs associated with the LoC meets an operator defined threshold, wherein meeting the operator defined threshold establishes the LoC.

6. The method of claim 5, wherein determining the geographic coverage area comprises:
identifying one or more geographical hexagonal cells targeted by the energy saving opportunity; and
determining that the one or more geographical hexagonal cells are experiencing the LoC based on the operator defined threshold being met.

7. The method of claim 1, wherein the mitigation measure is a recommendation to build a new cell site.
The method of claim 1, wherein the mitigation measure is utilizing neighbor tilt optimizations.

9. A system for mitigating loss of coverage (LoC) associated with an energy saving opportunity, the system comprising:
one or more antenna elements configured to transmit one or more downlink signals from a base station to one or more UEs located in a geographic coverage area; and
one or more computer processing components configured to perform operations comprising:
initiating the energy saving opportunity;
receiving a failed paging message, wherein the failed paging message is associated with the LoC caused by the energy saving opportunity;
based on receiving the failed paging message, determining the geographic coverage area is affected by the LoC;
implementing a tilt on a neighboring cell site; and
implementing a mitigation measure to mitigate the LoC affecting the geographic coverage area, wherein the mitigation measure is an adjustment to the energy saving opportunity.

10. The system of claim 9, wherein the energy saving opportunity is a massive multiple-input multiple-out (M-MIMO) cell sleep, a time-based cell sleep, a traffic-based cell sleep, or an intent-based cell sleep.

11. The system of claim 9, further comprising determining the energy saving opportunity caused the LoC based on the failed paging message, wherein determining the energy saving opportunity caused the LoC comprises:
processing per call measurement data (PCMD); and
based on the PCMD, determining that the failed paging message associated with the LoC meets an operator defined threshold, wherein meeting the operator defined threshold establishes the LoC.

12. The system of claim 11, wherein meeting the operator defined threshold further comprises:
transmitting the one or more downlink signals from the base station to one or more UEs located in the geographic coverage area;
receiving a response message from the one or more UEs, wherein the response message is the failed paging message; and
determining the response message was received after a duration that meets the operator defined threshold.

13. The system of claim 12, wherein the geographic coverage area is defined by a location of where the energy saving opportunity is initiated.

14. The system of claim 9, wherein the adjustment to the energy saving opportunity is to wake one or more cells that are in cell sleep.

15. One or more non-transitory computer readable media storing instructions that when executed via one or more processors perform a computerized method for mitigating loss of coverage (LoC) associated with an energy saving opportunity, the media comprising:
initiating the energy saving opportunity;
receiving a failed paging message, wherein the failed paging message is associated with the LoC caused by the energy saving opportunity;
based on receiving the failed paging message, determining a geographic coverage area affected by the LoC;
implementing a tilt on a neighboring cell site; and
implementing a mitigation measure to mitigate the LoC affecting the geographic coverage area, wherein the mitigation measure is recommending construction of a new cell site.

16. The media of claim 15, wherein the energy saving opportunity is a massive multiple-input multiple-out (M-MIMO) cell sleep, a time-based cell sleep, a traffic-based cell sleep, or an intent-based cell sleep.

17. The media of claim 15, wherein the energy saving opportunity is implemented during a maintenance window.

18. The media of claim 15, further comprising determining the energy saving opportunity caused the LoC based on the failed paging message, wherein determining the energy saving opportunity caused the LoC comprises:
processing per call measurement data (PCMD); and
based on the PCMD, determining that the failed paging message associated with the LoC meets an operator defined threshold, wherein meeting the operator defined threshold establishes the LoC.

19. The media of claim 18, wherein meeting the operator defined threshold further comprises:
transmitting one or more downlink signals from a base station to one or more UEs located in the geographic coverage area;
receiving a response message from the one or more UEs, wherein the response message is the failed paging message; and
determining the response message was received after a duration that meets the operator defined threshold.

20. The media of claim 19, wherein the geographic coverage area is defined by a location of where the energy saving opportunity is initiated.
